(19) United States
(12) Patent Application Publication
(10) Pub. No.: US 2020/0286023 A1
(43) Pub. Date: Sep. 10, 2020

(54) Item Separation Method And Apparatus, And Computer-Readable Storage Medium

(71) Applicant: HUAWEI TECHNOLOGIES CO., LTD., Shenzhen (CN)

(72) Inventors: Xialiang TONG, Shenzhen (CN); Mingxuan YUAN, Hong Kong (CN); Jia ZENG, Hong Kong (CN); Lei CHEN, Shenzhen (CN)

(21) Appl. No.: 16/880,640

(22) Filed: May 21, 2020

Related U.S. Application Data
(63) Continuation of application No. PCT/CN2018/093591, filed on Jun. 29, 2018.

(30) Foreign Application Priority Data
Nov. 28, 2017 (CN) 201711213382.6

(51) Int. Cl. G06Q 10/06; G05B 17/02; G06Q 10/04

(52) U.S. Cl. CPC G06Q 10/06315; G06Q 10/04; G05B 17/02

(57) ABSTRACT

The present disclosure relates to item separation methods. One example method includes receiving a to-be-processed order, where the to-be-processed order includes a type of a to-be-separated item and a quantity of to-be-separated items, and obtaining a separation configuration of the to-be-processed order based on the to-be-processed order and a separation configuration of a historical order included in a separation database, where the separation configuration of the to-be-processed order includes a type of a box for packing the to-be-separated item and a first quantity of boxes, and the separation configuration of the historical order includes a type of an item, a quantity of items, a type of a box for packing the item, and a second quantity of boxes.

### CROSS-REFERENCE TO RELATED APPLICATIONS

This application is a continuation of International Application No. PCT/CN2018/093591, filed on Jun. 29, 2018, which claims priority to Chinese Patent Application No. 201711213382.6, filed on Nov. 28, 2017. The disclosures of the aforementioned applications are hereby incorporated by reference in their entireties.

### TECHNICAL FIELD

This application relates to logistics technologies, and in particular, to an item separation method and apparatus, and a computer-readable storage medium.

### BACKGROUND

Logistics refers to a process of physically moving an item from a supplying place to a receiving place. For ease of item transportation and protection, sales promotion, and the like, packing is required before the item is transported. Item packing includes processes such as loading items into boxes and separating items into boxes. When there are many items (for example, several hundreds of thousands of types of materials) and many types (for example, thousands of types) of boxes, separating these items into appropriate boxes is very labor-consuming.

In the prior art, in one manner, manual separation is used. This separation manner is insufficient and labor-consuming. In addition, people separate items mainly based on experience, and this is error-prone. For example, same items are packed in different manners, resulting in a customer complaint about packing inconsistency. In another manner, an intelligent packing system automatically performs separation. The intelligent packing system includes an ultrasonic measurement module, a multi-specification-packing box picking module, a four-direction box sealing module, and a 360-degree tape adhesion module. The ultrasonic measurement module is configured to measure a volume of an item. The multi-specification-packing box picking module is configured to select a packing box with an appropriate size based on the volume of the item. The four-direction box sealing module is configured to: arrange and load the item into the box. The 360-degree tape adhesion module is configured to seal the packing box by using an adhesive tape.

In the latter manner, a human error can be avoided, labor resources can be reduced, and a packing speed and efficiency can be improved. However, a hardware device needs to be used to measure the volume of the item in real time, to find the appropriate packing box, resulting in relatively high costs. In addition, a volume of an item that can be measured by the intelligent packing system is limited, and the intelligent packing system is not applicable to all items.

### SUMMARY

This application provides an item separation method and apparatus, and a computer-readable storage medium, to improve separation efficiency and accuracy.

A first aspect of this application provides an item separation method, including: receiving a to-be-processed order, where the to-be-processed order includes a type of a to-be-separated item and a quantity of to-be-separated items; and determining a separation configuration of the to-be-processed order based on the to-be-processed order and a separation configuration of a historical order included in a separation database, where the separation configuration of the to-be-processed order includes a type of a box for packing the to-be-separated item and a quantity of boxes, and the separation configuration of the historical order includes a type of an item, a quantity of items, a type of a box for packing the item, and a quantity of boxes. According to the method, the separation configuration of the to-be-processed order can be automatically generated by using the separation configuration of the historical order, so that separation efficiency and accuracy are improved. In addition, the method may be implemented by using general-purpose hardware, and no additional device needs to be purchased, so that separation costs are low. In addition, the method is not limited by a type and a volume of an item, and is applicable to many scenarios.

Optionally, the determining a separation configuration of the to-be-processed order based on the to-be-processed order and a separation configuration of a historical order included in a separation database includes:

matching the to-be-processed order with the historical order included in the separation database, to obtain at least one candidate separation configuration of the to-be-processed order, where each candidate separation configuration includes all or some separation configurations of at least one historical order, a combination of historical orders included in each candidate separation configuration covers at least the to-be-separated item included in the to-be-processed order, a real loading rate of a box included in each candidate separation configuration meets a preset condition, and the real loading rate is a real loading rate obtained when the box is used to pack the to-be-separated item and determining the separation configuration of the to-be-processed order according to an optimization policy based on the at least one candidate separation configuration.

Optionally, before the determining the separation configuration of the to-be-processed order according to an optimization policy based on the at least one candidate separation configuration, the method further includes:

determining a replaceable item of the to-be-separated item according to a pre-obtained item replacement rule, where the item replacement rule includes at least one pair of replaceable items and a quantity of each type of replaceable items in each pair, and sums of three-dimensional sizes of two types of items included in each pair of replaceable items are the same, or a difference between the sums of the three-dimensional sizes is less than a first threshold;

replacing the replaceable item in the historical order with the to-be-separated item, to obtain a virtual order; and

matching the to-be-processed order with the virtual order, to obtain at least one virtual candidate separation configuration of the to-be-processed order, where each virtual candidate separation configuration includes all or some separation configurations of at least one virtual order, a combination of virtual orders included in each virtual candidate separation configuration covers at least the to-be-separated item included in the to-be-processed order, and a real loading rate of a box included in each virtual candidate separation configuration meets the preset condition; and

the determining the separation configuration of the to-be-processed order according to an optimization policy based on the at least one candidate separation configuration includes:

determining the separation configuration of the to-be-processed order according to the optimization policy based on the at least one candidate separation configuration and the at least one virtual candidate separation configuration.

Optionally, before the determining a replaceable item of the to-be-separated item according to a pre-obtained item replacement rule, the method further includes: determining the item replacement rule based on the type of the item, the quantity of items, and the type of the used box that are in the historical order.

Optionally, the matching the to-be-processed order with the historical order included in the separation database, to obtain at least one candidate separation configuration of the to-be-processed order includes: performing at least one level of matching on the to-be-processed order and the historical order included in the separation database, to obtain the at least one candidate separation configuration of the to-be-processed order, where matching granularities are in descending order from first-level matching to last-level matching.

Optionally, the performing at least one level of matching on the to-be-processed order and the historical order included in the separation database, to obtain the at least one candidate separation configuration of the to-be-processed order includes: when no candidate separation configuration is obtained in current-level matching, performing next-level matching on the to-be-processed order and the historical order included in the separation database.

Optionally, a process of each level of matching includes the following steps:

matching the to-be-processed order with the historical order based on a matching granularity of the current-level matching, to obtain at least one primary separation configuration, where each primary separation configuration includes all or some separation configurations of at least one historical order, and a combination of historical orders included in each primary separation configuration covers at least the to-be-separated item included in the to-be-processed order;

for each primary separation configuration, calculating, based on a volume and/or a weight of the to-be-separated item, a real loading rate of each box included in the primary separation configuration; and determining a candidate separation configuration in the at least one primary separation configuration, where the candidate separation configuration is a primary separation configuration in which a real loading rate ofa box meets the preset condition.

Optionally, the matching the to-be-processed order with the virtual order, to obtain at least one virtual candidate separation configuration of the to-be-processed order includes: performing at least one level of matching on the to-be-processed order and the virtual order, to obtain the at least one virtual candidate separation configuration of the to-be-processed order, where matching granularities are in descending order from first-level matching to last-level matching.

Optionally, the performing at least one level of matching on the to-be-processed order and the virtual order, to obtain the at least one virtual candidate separation configuration of the to-be-processed order includes: when no virtual candidate separation configuration is obtained in current-level matching, performing next-level matching on the to-be-processed order and the virtual order.

Optionally, a process of each level of matching includes the following steps:

matching the to-be-processed order with the virtual order, to obtain at least one primary virtual separation configuration, where each primary virtual separation configuration includes all or some separation configurations of at least one virtual order, and a combination of virtual orders included in each primary virtual separation configuration covers at least the to-be-separated item included in the to-be-processed order:

for each primary virtual separation configuration, calculating, based on a volume and/or a weight of the to-be-separated item, a real loading rate of each box included in the primary virtual separation configuration; and determining a virtual candidate separation configuration in the at least one primary virtual separation configuration, where the virtual candidate separation configuration is a primary virtual separation configuration in which a real loading rate of a box meets the preset condition.

Optionally, the method further includes: calculating, based on a type of an item and a quantity of items included in the separation database, a volume and a weight of each type of item included in the separation database.

Optionally, the calculating, based on a type of an item and a quantity of items included in the separation database, a volume of each type of item included in the separation database includes:

performing the following processing process for each item, where the processing process includes:

determining, in the historical order included in the separation database, a box set R loaded with the item;

establishing a model, where a type of an item included in each box in the box set R is C, a quantity of items included in each box in the box set R is Q, a vacancy rate tᵢ∈[0,1) a vacancy rate threshold β∈[0,1), a volume of the type of item is vᵢ, and ∃vᵢ∈V, where

the model meets:

restrictions: ∃i∈R and (1−tᵢ)×rᵢ≤Σⱼ₌₁^{C}vⱼ×qᵢ≤rᵢ; and

an optimization policy: minimizing t₁+t₂+ . . . +tₙ; and

calculating a volume vᵢ of each type of item and a vacancy rate tᵢ of each box, and if the vacancy rate tᵢ is greater than the vacancy rate threshold β, deleting the box whose vacancy rate tᵢ is greater than the vacancy rate threshold β from the box set R, and returning to perform the step of establishing a model, until vacancy rates tᵢ of all boxes in the box set R are less than the vacancy rate threshold β.

A second aspect of this application provides an item separation apparatus, including:

a receiving module, configured to receive a to-be-processed order, where the to-be-processed order includes a type of a to-be-separated item and a quantity of to-be-separated items; and

a first determining module, configured to determine a separation configuration of the to-be-processed order based on the to-be-processed order and a separation configuration of a historical order included in a separation database, where the separation configuration of the to-be-processed order includes a type of a box for packing the to-be-separated item and a quantity of boxes, and the separation configuration of the historical order includes a type of an item, a quantity of items, a type of a box for packing the item and a quantity of boxes.

Optionally, the first determining module includes:

a first matching submodule, configured to match the to-be-processed order with the historical order included in the separation database, to obtain at least one candidate separation configuration of the to-be-processed order, where each candidate separation configuration includes all or some separation configurations of at least one historical order, a combination of historical orders included in each candidate separation configuration covers at least the to-be-separated item included in the to-be-processed order, a real loading rate of a box included in each candidate separation configuration meets a preset condition, and the real loading rate is a real loading rate obtained when the box is used to pack the to-be-separated item; and

a first determining submodule, configured to determine the separation configuration of the to-be-processed order according to an optimization policy based on the at least one candidate separation configuration.

Optionally, the first determining module further includes:

a second determining submodule, configured to determine a replaceable item of the to-be-separated item according to a pre-obtained item replacement rule, where the item replacement rule includes at least one pair of replaceable items and a quantity of each type of replaceable items in each pair, and sums of three-dimensional sizes of two types of items included in each pair of replaceable items are the same, or a difference between the sums of the three-dimensional sizes is less than a first threshold;

a replacement submodule, configured to replace the replaceable item in the historical order with the to-be-separated item, to obtain a virtual order; and

a second matching submodule, configured to match the to-be-processed order with the virtual order, to obtain at least one virtual candidate separation configuration of the to-be-processed order, where each virtual candidate separation configuration includes all or some separation configurations of at least one virtual order, a combination of virtual orders included in each virtual candidate separation configuration covers at least the to-be-separated item included in the to-be-processed order, and a real loading rate of a box included in each virtual candidate separation configuration meets the preset condition; and

the first determining submodule is specifically configured to determine the separation configuration of the to-be-processed order according to the optimization policy based on the at least one candidate separation configuration and the at least one virtual candidate separation configuration.

Optionally, the apparatus further includes a second determining module, configured to determine the item replacement rule based on the type of the item, the quantity of items, and the type of the used box that are in the historical order.

Optionally, the first matching submodule is specifically configured to perform at least one level of matching on the to-be-processed order and the historical order included in the separation database, to obtain the at least one candidate separation configuration of the to-be-processed order, where matching granularities are in descending order from first-level matching to last-level matching.

Optionally, that the first matching submodule performs at least one level of matching on the to-be-processed order and the historical order included in the separation database, to obtain the at least one candidate separation configuration of the to-be-processed order includes: when no candidate separation configuration is obtained in current-level matching, performing next-level matching on the to-be-processed order and the historical order included in the separation database.

Optionally, a process of each level of matching includes the following steps:

matching the to-be-processed order with the historical order based on a matching granularity of the current-level matching, to obtain at least one primary separation configuration, where each primary separation configuration includes all or some separation configurations of at least one historical order, and a combination of historical orders included in each primary separation configuration covers at least the to-be-separated item included in the to-be-processed order:

for each primary separation configuration, calculating, based on a volume and/or a weight of the to-be-separated item, a real loading rate of each box included in the primary separation configuration; and

determining a candidate separation configuration in the at least one primary separation configuration, where the candidate separation configuration is a primary separation configuration in which a real loading rate of a box meets the preset condition.

Optionally, the second matching submodule is specifically configured to perform at least one level of matching on the to-be-processed order and the virtual order, to obtain the at least one virtual candidate separation configuration of the to-be-processed order, where matching granularities are in descending order from first-level matching to last-level matching.

Optionally, that the second matching submodule performs at least one level of matching on the to-be-processed order and the virtual order, to obtain the at least one virtual candidate separation configuration of the to-be-processed order includes: when no virtual candidate separation configuration is obtained in current-level matching, performing next-level matching on the to-be-processed order and the virtual order.

Optionally, a process of each level of matching includes the following steps:

matching the to-be-processed order with the virtual order, to obtain at least one primary virtual separation configuration, where each primary virtual separation configuration includes all or some separation configurations of at least one virtual order, and a combination of virtual orders included in each primary virtual separation configuration covers at least the to-be-separated item included in the to-be-processed order;

for each primary virtual separation configuration, calculating, based on a volume and/or a weight of the to-be-separated item, a real loading rate of each box included in the primary virtual separation configuration; and

determining a virtual candidate separation configuration in the at least one primary virtual separation configuration, where the virtual candidate separation configuration is a primary virtual separation configuration in which a real loading rate of a box meets the preset condition.

Optionally, the apparatus further includes a calculation module, configured to calculate, based on a type of an item and a quantity of items included in the separation database, a volume and a weight of each type of item included in the separation database.

Optionally, the calculation module is specifically configured to:

perform the following processing process for each item, where the processing process includes:

determining, in the historical order included in the separation database, a box set R loaded with the item;

establishing a model, where a type of an item included in each box in the box set R is C, a quantity of items included in each box in the box set R is Q, a vacancy rate tᵢ∈[0,1), a vacancy rate threshold β[0,1), a volume of the type of item is vᵢ, and ∃vᵢ∈V, where

the model meets:

restrictions: ∃rᵢ∈R and (1−tᵢ)×rᵢ≤Σⱼ₌₁^{C}vⱼ×qᵢ≤rᵢ; and

an optimization policy: minimizing t₁+t₂+ . . . +tₙ; and

calculating a volume vᵢ of each type of item and a vacancy rate tᵢ of each box, and if the vacancy rate tᵢ is greater than the vacancy rate threshold β, deleting the box whose vacancy rate tᵢ is greater than the vacancy rate threshold β from the box set R, and returning to perform the step of establishing a model, until vacancy rates tᵢ of all boxes in the box set R are less than the vacancy rate threshold β.

A third aspect of this application provides an item separation apparatus, including a processor, a memory, and a transceiver, where the memory is configured to store an instruction, the transceiver is configured to communicate with another device, and the processor is configured to execute the instruction stored in the memory, so that the item separation apparatus performs the method provided in the first aspect of this application and the optional manners of the first aspect.

A fourth aspect of this application provides a computer-readable storage medium, applied to an item separation apparatus, where the computer-readable storage medium stores an instruction, and when the instruction is executed by a computing apparatus, the item separation apparatus is enabled to perform the method provided in the first aspect of this application and the optional manners of the first aspect.

According to the item separation method and apparatus, and the computer-readable storage medium, the method includes: receiving the to-be-processed order, where the to-be-processed order includes the type of the to-be-separated item and the quantity of to-be-separated items; and determining the separation configuration of the to-be-processed order based on the to-be-processed order and the separation configuration of the historical order included in the separation database, where the separation configuration of the to-be-processed order includes the type of the box for packing the to-be-separated item and the quantity of boxes, and the separation configuration of the historical order includes the type of the item, the quantity of items, the type of the box for packing the item, and the quantity of boxes. According to the method, the separation configuration of the to-be-processed order can be automatically generated by using the separation configuration of the historical order, so that separation efficiency and accuracy are improved. In addition, the method may be implemented by using general-purpose hardware, and no additional device needs to be purchased, so that separation costs are low. In addition, the method is not limited by a type and a volume of an item, and is applicable to many scenarios.

### BRIEF DESCRIPTION OF DRAWINGS

FIG. 1 is a flowchart of an item separation method according to Embodiment 1 of this application,

FIG. 2 is a flowchart of an item separation method according to Embodiment 2 of this application:

FIG. 3 is a schematic diagram of first-level matching;

FIG. 4 is a schematic diagram of second-level matching:

FIG. 5 is a schematic diagram of third-level matching:

FIG. 6 is a flowchart of an item separation method according to Embodiment 3 of this application:

FIG. 7 is a schematic diagram of item replacement rule mining:

FIG. 8 is a schematic structural diagram of an item separation apparatus according to Embodiment 6 of this application;

FIG. 9 is a schematic structural diagram of an item separation apparatus according to Embodiment 7 of this application;

FIG. 10 is a schematic structural diagram of an item separation apparatus according to Embodiment 9 of this application; and

FIG. 11 is a schematic structural diagram of an item separation apparatus according to Embodiment 10 of this application.

### DESCRIPTION OF EMBODIMENTS

This application provides an item separation method. The item separation method may be applied to a general-purpose hardware device, for example, a terminal device or a server. The terminal device or the server has a data processing function, and is connected to and communicates with a network. The terminal device may be a wireless terminal. The wireless terminal may be a device that provides a user with voice and/or data connectivity, a handheld device with a wireless connection function, or another processing device connected to a wireless modem. The wireless terminal may be a mobile terminal such as a mobile phone (or referred to as a “cellular” phone) and a computer with a mobile terminal. For example, the wireless terminal may be a portable, pocket-sized, handheld, computer built-in, or in-vehicle mobile apparatus, which exchanges voice and/or data with a radio access network. The wireless terminal may also be referred to as a subscriber unit, a subscriber station, a mobile station, a mobile console, a remote station, an access point, a remote terminal, an access terminal, a user terminal, user equipment (UE), or a user agent. This is not limited herein. Certainly, the item separation method may be alternatively applied to a dedicated device.

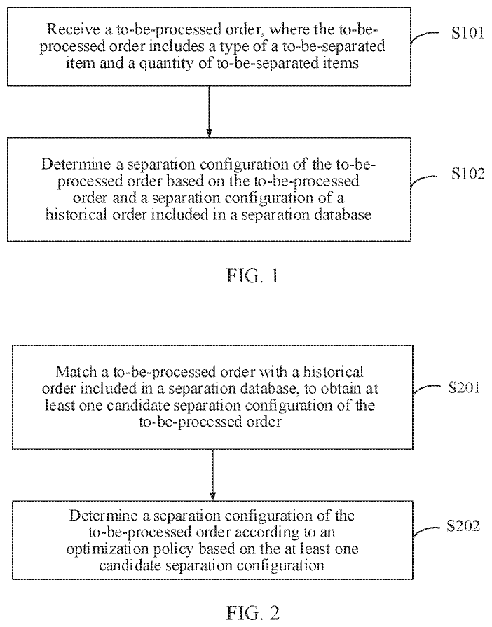

FIG. 1 is a flowchart of an item separation method according to Embodiment 1 of this application. The method in this embodiment is completed by an item separation apparatus. As shown in FIG. 1, the method provided in this embodiment includes the following steps.

Step S101: Receive a to-be-processed order, where the to-be-processed order includes a type of a to-be-separated item and a quantity of to-be-separated items.

The to-be-processed order is entered by a user by using an input apparatus. The to-be-processed order may include one or more types of to-be-separated items, and quantities of all the types of to-be-separated items may be the same or may be different.

Step S102: Determine a separation configuration of the to-be-processed order based on the to-be-processed order and a separation configuration of a historical order included in a separation database.

The separation configuration of the to-be-processed order includes a type of a box for packing the to-be-separated item and a quantity of boxes, and a separation configuration of each historical order includes a type of an item, a quantity of items, a type of a box for packing the item, and a quantity of boxes. The separation configuration of each historical order includes one or more types of items. The separation configuration of the historical order included in the separation database is collected and maintained by the item separation apparatus. In a process, the item separation apparatus may continuously collect a separation configuration of a new historical order, to supplement the separation database, so that the separation database is applicable to more scenarios.

The separation configuration of the historical order is mainly from the following two aspects: an actual historical order and a separation rule. The separation rule is usually used to guide manual separation. In this embodiment, after collecting the separation rule, the item separation apparatus generates a corresponding separation configuration according to the separation rule, and stores, in the separation database, the separation configuration corresponding to the separation rule. Because the separation rule may change frequently, the separation rule is converted into the separation configuration, to facilitate data maintenance and update.

In an implementation, the item separation apparatus matches the to-be-processed order with the historical order included in the separation database, to obtain at least one candidate separation configuration of the to-be-processed order, and determines the separation configuration of the to-be-processed order according to an optimization policy based on the at least one candidate separation configuration. Each candidate separation configuration includes all or some separation configurations of at least one historical order, a combination of historical orders included in each candidate separation configuration covers at least the to-be-separated item included in the to-be-processed order, and a real loading rate of a box included in each candidate separation configuration meets a preset condition. The real loading rate is a percentage ofa volume of an actual item in a box in a volume of the entire box, namely, volume utilization of the box. Usually, a higher real loading rate of a box is better. Each candidate separation configuration may include a plurality of boxes, and real loading rates of all the boxes may be different. The preset condition is, for example, that real loading rates of all boxes in the candidate separation configuration are greater than a first threshold, or that real loading rates of some boxes are greater than the first threshold. For example, the preset condition is that real loading rates of 80% or 90% boxes in the candidate separation configuration are greater than the first threshold. It should be clear that, in this embodiment, the real loading rate of the box included in the candidate separation configuration is a real loading rate obtained when the box is used to pack the to-be-separated item, but is not a real loading rate obtained when the box is used to pack the item in the historical order.

For example, one candidate separation configuration includes two historical orders, a historical order 1 includes five items A and 10 items B that occupy one large box in total, a historical order 2 includes 10 items C and five items D that occupy one large box in total, and the to-be-processed order includes five items A and five items C. It can be learned that a combination of the historical order 1 and the historical order 2 can cover all to-be-separated items included in the to-be-processed order. When a real loading rate of the box included in the historical order 1 is calculated, the real loading rate needs to be calculated by using a ratio of a volume of the five items A to a volume of the box. When a real loading rate of the box included in the historical order 2 is calculated, the real loading rate needs to be calculated by using a ratio of a volume of five items C to a volume of the box, instead of calculating the real loading rate by using a ratio of a volume of the 10 items C to the volume of the box.

Optionally, the item separation apparatus performs at least one level of matching on the to-be-processed order and the historical order included in the separation database, to obtain the at least one candidate separation configuration of the to-be-processed order. Matching granularities are in descending order from first-level matching to last-level matching.

In a first matching manner, only when no candidate separation configuration is obtained in current-level matching, the item separation apparatus performs next-level matching on the to-be-processed order and the historical order included in the separation database; or when a candidate separation configuration is obtained in current-level matching, the item separation apparatus determines that the candidate separation configuration obtained in the current-level matching is a candidate separation configuration of the to-be-processed order. Therefore, when the candidate separation configuration is obtained in the current-level matching, the next-level matching is no longer performed.

In a second matching manner, when a candidate separation configuration is obtained in current-level matching, the item separation apparatus continues to perform next-level matching until matching is completed at all granularities, and candidate separation configurations obtained in all levels of matching are used as candidate separation configurations of the to-be-processed order. Usually, if a candidate separation configuration can be obtained in large-granularity matching, a candidate separation configuration can also be obtained in subsequent small-granularity matching.

The matching granularities are in descending order from the first-level matching to the last-level matching. Optionally, it is assumed that three levels of matching are performed, and matching granularities in descending order are successively an order granularity, a large-box granularity, and a small-box granularity. One order includes at least one large box or small box, and one large box can accommodate at least one small box. The large box may be a smallest pack transport unit (SPU), and the small box may be a smallest kit unit (SKU). When the first matching manner is used, the item separation apparatus may perform only matching at the order granularity, may perform only matching at the order granularity and matching at the large-box granularity, or may perform matching at the three granularities to obtain the candidate separation configuration of the to-be-processed order. When the second matching manner is used, the item separation apparatus needs to perform matching at the three granularities.

In an example in which the first matching manner is used, a process of three levels of matching is as follows: The item separation apparatus first performs first-level matching. If a candidate separation configuration is obtained in the first-level matching, the matching process ends, and the candidate separation configuration obtained in the first-level matching is used as a candidate separation configuration of the to-be-processed order. If no candidate separation configuration is obtained in the first-level matching, second-level matching is performed. If a candidate separation configuration is obtained in the second-level matching, the matching process ends, and the candidate separation configuration obtained in the second-level matching is used as a candidate separation configuration of the to-be-processed order. If no candidate separation configuration is obtained in the second-level matching, third-level matching is performed. If a candidate separation configuration is obtained in the third-level matching, the matching process ends, and the candidate separation configuration obtained in the third-level matching is used as a candidate separation configuration of the to-be-processed order. If no candidate separation configuration is obtained in the third-level matching, the matching process ends, and it indicates that matching fails. The item separation apparatus may output matching failure notification information, to notifyr a user that no candidate separation configuration of the to-be-processed order is obtained through matching.

There may be one or more candidate separation configurations of the to-be-processed order. When there are a plurality of candidate separation configurations, the item separation apparatus selects, from the plurality of candidate separation configurations, an optimal candidate separation configuration as the separation configuration of the to-be-processed order according to the optimization policy. Optionally, optimization policies used in all the levels of matching may be the same or may be different. The optimization policy may be that a quantity of used boxes is the smallest, a volume of a used box is the smallest, or separation costs are the lowest. The item separation apparatus may determine the separation configuration of the to-be-processed order from the plurality of candidate separation configurations by using a heuristic algorithm according to the optimization policy. Alternatively, the item separation apparatus may determine the separation configuration of the to-be-processed order from the plurality of candidate separation configurations by using a dynamic programming algorithm according to the optimization policy.

In this application, some items can be replaced with each other. For example, an item A and an item D have basically same three-dimensional sizes and weights. If the historical order includes only a separation configuration of the item A, the item A may be replaced with the item D, to obtain some virtual orders, to expand a matching range of the to-be-processed order. Correspondingly, in another manner, the to-be-processed order is first matched with the historical order included in the separation database, to obtain the at least one candidate separation configuration of the to-be-processed order; then, a replaceable item of the to-be-separated item is determined according to a pre-obtained item replacement rule, where the item replacement rule includes at least one pair of replaceable items and a quantity of each type of replaceable items in each pair, and sums of three-dimensional sizes of two types of items included in each pair of replaceable items are the same, or a difference between the sums of the three-dimensional sizes is less than the first threshold; the replaceable item in the historical order is replaced with the to-be-separated item, to obtain a virtual order; the to-be-processed order is matched with the virtual order, to obtain at least one virtual candidate separation configuration of the to-be-processed order; and finally, the separation configuration of the to-be-processed order is determined according to the optimization policy based on the at least one candidate separation configuration and the at least one virtual candidate separation configuration.

In this embodiment, the to-be-processed order is received, where the to-be-processed order includes the type of the to-be-separated item and the quantity of to-be-separated items; and the separation configuration of the to-be-processed order is determined based on the to-be-processed order and the separation configuration of the historical order included in the separation database, where the separation configuration of the to-be-processed order includes the type of the box for packing the to-be-separated item and the quantity of boxes, and the separation configuration of the historical order includes the type of the item, the quantity of items, the type of the box for packing the item, and the quantity of boxes. According to the method, the separation configuration of the to-be-processed order can be automatically generated by using the separation configuration of the historical order, so that separation efficiency and accuracy are high. In addition, the method may be implemented by using general-purpose hardware, and no additional device needs to be purchased, so that separation costs are low. In addition, the method is not limited by a type and a volume of an item, and is applicable to many scenarios.

FIG. 2 is a flowchart of an item separation method according to Embodiment 2 of this application. In the method in this embodiment, an item separation apparatus determines a candidate separation configuration of a to-be-processed order based on a historical order. As shown in FIG. 2, the method in this embodiment includes the following steps.

Step S201: Match the to-be-processed order with the historical order included in a separation database, to obtain at least one candidate separation configuration of the to-be-processed order.

Optionally, the candidate separation configuration of the to-be-processed order may be obtained through multi-level matching. Optionally, the item separation apparatus performs at least one level of matching on the to-be-processed order and the historical order included in the separation database, to obtain the at least one candidate separation configuration of the to-be-processed order. Matching granularities are in descending order from first-level matching to last-level matching. Optionally, when multi-level matching is performed, and no candidate separation configuration is obtained in current-level matching, next-level matching is performed on the to-be-processed order and the historical order included in the separation database.

A processor of each level of matching includes the following steps: matching, based on a matching granularity of the current-level matching, the to-be-processed order with the historical order included in the separation database, to obtain at least one primary separation configuration, where each primary separation configuration includes all or some separation configurations of at least one historical order, and a combination of historical orders included in each primary separation configuration can cover a to-be-separated item included in the to-be-processed order; for each primary separation configuration, calculating, based on a volume and/or a weight of the to-be-separated item, a real loading rate of each box included in the primary separation configuration; and determining a candidate separation configuration in the at least one primary separation configuration, where the candidate separation configuration is a primary separation configuration in which a real loading rate of a box meets a preset condition.

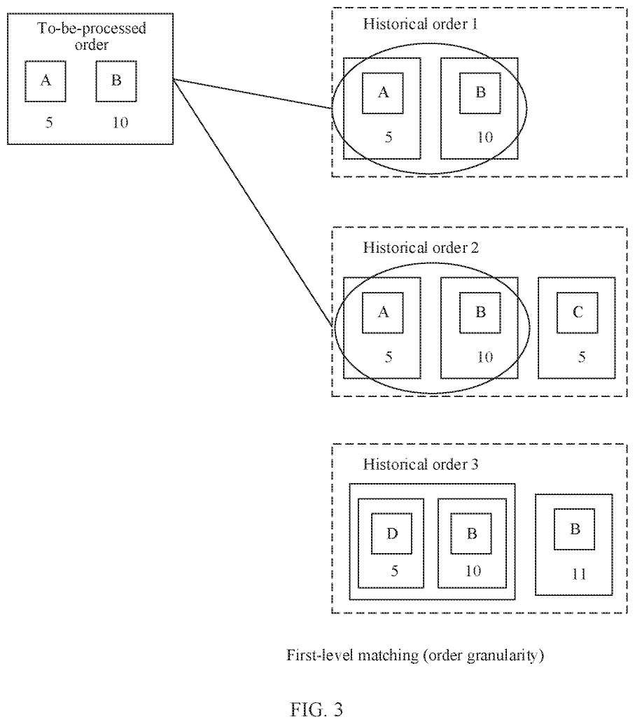

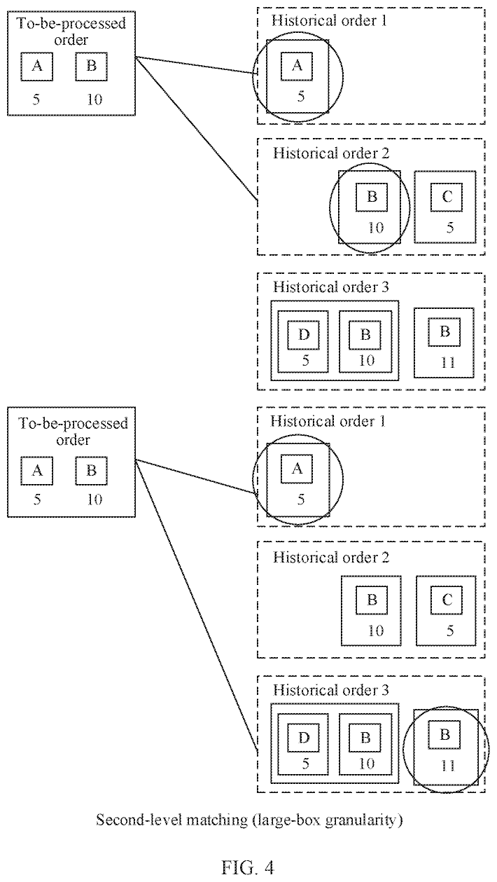

Three levels of matching are used as an example. It is assumed that a matching granularity of first-level matching is an order granularity, and matching at the order granularity cannot be performed across orders. FIG. 3 is a schematic diagram of first-level matching. As shown in FIG. 3, the to-be-processed order includes two types of to-be-separated items: items A and items B, there are five items A. and there are 10 items B. It is assumed that the separation database includes three historical orders: a historical order 1 that includes five items A and 10 items B, a historical order 2 that includes five items A, 10 items B, and five items C, and a historical order 3 that includes five items D and 21 items B. A separation configuration of the historical order 1 is that the items A and the items B occupy one large box, a separation configuration of the historical order 2 is that the items A, the items B, and the items C occupy one large box, and a separation configuration of the historical order 3 is that the items D and 10 items B occupy one small box, and the small box and 11 items B are loaded into a large box.

Because the matching at the order granularity cannot be performed across orders, a historical order needs to include all to-be-separated items in the to-be-processed order, so that the historical order can be used as a historical order of the candidate separation configuration. As shown in FIG. 3, two candidate separation configurations are obtained in the matching at the order granularity. A first candidate separation configuration includes all separation configurations of the historical order 1, and a second candidate separation configuration includes some separation configurations of the historical order 2. The to-be-processed order completely matches the historical order 1 in the first candidate separation configuration, and the to-be-processed order partially matches the historical order 2 in the second candidate separation configuration.

FIG. 4 is a schematic diagram of second-level matching. A matching granularity of the second-level matching is a large-box granularity. As shown in FIG. 4, it is assumed that the separation database includes three historical orders: a historical order 1 that includes five items A, a historical order 2 that includes 10 items B and five items C, and a historical order 3 that includes five items D and 21 items B. A separation configuration of the historical order 1 is that the items A occupy one large box, a separation configuration of the historical order 2 is that the items B and the items C occupy one large box, and a separation configuration of the historical order 3 is that the items D and 10 items B occupy one small box, and the small box and 11 items B are loaded into a large box.

Because the matching at the order granularity cannot be performed across orders, no candidate separation configuration can be obtained in the first-level matching, and the second-level matching needs to be performed. The matching granularity of the second-level matching can cross orders. Therefore, a historical order may be used as a historical order of the candidate separation configuration provided that the historical order includes one type of to-be-separated item in the to-be-processed order. As shown in FIG. 4, two candidate separation configurations are obtained in the second-level matching. A first candidate separation configuration includes the historical order 1 and the historical order 2, and a separation configuration of the items A in the historical order 1 and a separation configuration of the items B in the historical order 2 are separately selected and are combined to obtain the first candidate separation configuration. A second candidate separation configuration includes the historical order 1 and the historical order 3, and the historical order 1 and a separation configuration of items B in the historical order 3 are separately selected and are combined to obtain the second candidate separation configuration. It should be noted that, in the second candidate separation configuration, the items B outside the small box in the historical order 3 are selected, but the items B in the small box cannot be selected. The first candidate separation configuration is obtained through complete matching, and the second candidate separation configuration is obtained through partial matching.

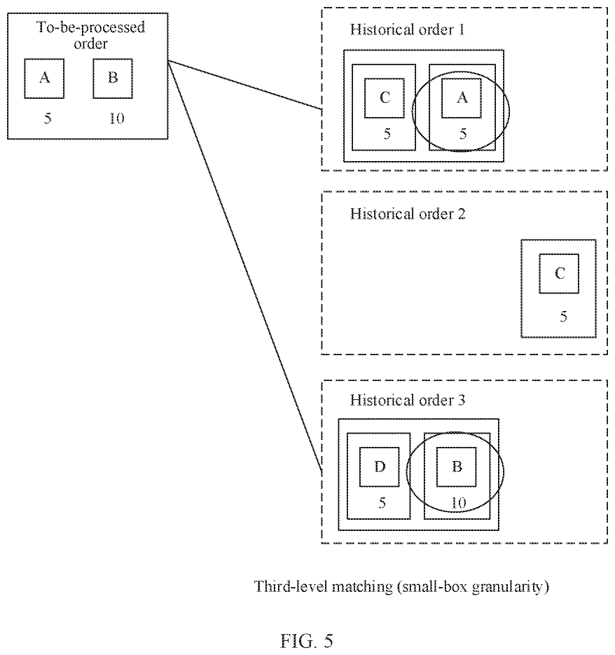

FIG. 5 is a schematic diagram of third-level matching. A matching granularity of the third-level matching is a small-box granularity. As shown in FIG. 5, it is assumed that the separation database includes three historical orders: a historical order 1 that includes five items A and five items C, a historical order 2 that includes five items C, and a historical order 3 that includes five items D and 10 items B. A separation configuration of the historical order 1 is that the items A and the items C occupy one small box, a separation configuration of the historical order 2 is that the items B and the items C occupy one large box, and a separation configuration of the historical order 3 is that the items D and the items B occupy one small box, and the small box is loaded into a large box.

It can be learned from FIG. 5 that no candidate separation configuration can be obtained in the matching at the order granularity and the matching at the large-box granularity. Therefore, the third-level matching needs to be performed. A candidate separation configuration can be obtained in the third-level matching. The candidate separation configuration includes the historical order 1 and the historical order 3, and a separation configuration of the items A in the small box in the historical order 1 and a separation configuration of the items B in the small box in the historical order 3 are separately selected and are combined to obtain the candidate separation configuration.

Examples shown in FIG. 3 to FIG. 5 are relatively simple. In an actual use process, the to-be-processed order may include more items. Therefore, each candidate separation configuration may include a plurality of types of boxes, types and quantities of items packed in all the types of boxes may be different, and quantities of items packed in boxes of a same type may also be different.

In this embodiment, before the real loading rate of each box included in the primary separation configuration is calculated, a volume and a weight of each type of item included in the separation database need to be calculated based on a type of an item and a quantity of items included in the separation database. Optionally, the volume of the type of item may be calculated in the following manner:

performing the following processing process for each item, where the processing process includes:

determining, in the historical order included in the separation database, a box set R loaded with the item;

establishing a model, where a type of an item included in each box in the box set R is C, a quantity of items included in each box in the box set R is Q, a vacancy rate tᵢ∈[0,1), a vacancy rate threshold β∈[0,1), a volume of the type of item is vᵢ, and ∃vᵢ∈, where

the model meets:

restrictions: ∃rᵢ∈R and (1−tᵢ)×rᵢ≤Σⱼ₌₁^{C}vⱼ×qᵢ≤rᵢ; and

an optimization policy: minimizing t₁+t₂+ . . . +tₙ; and

a meaning of the model is that a sum of volumes of all items in a box is smaller than an actual volume of the box, and it is ensured that a real loading rate of the box is as high as possible, in other words, a vacancy rate tᵢ of the box is as low as possible; and

calculating a volume vᵢ of each type of item and a vacancy rate tᵢ of each box, and if the vacancy rate tᵢ is greater than the vacancy rate threshold β, deleting the box whose vacancy rate tᵢ is greater than the vacancy rate threshold a from the box set R, and returning to perform the step of establishing a model, until vacancy rates tᵢ of all boxes in the box set R are less than the vacancy rate threshold β, where vacancy rate tᵢ of the box=1−real loading rate.

Likewise, the weight of each type of item may be obtained by using a similar modeling method.

When the real loading rate of each box included in the primary separation configuration is calculated, an intersection of each box and the to-be-separated item included in the to-be-processed order is extracted, and the real loading rate of the box is calculated based on a quantity of to-be-separated items in the intersection. For example, in the example shown in FIG. 3, real loading rate of a box included in the first candidate separation configuration=(5×volume of an item A+10×volume of an item B)/volume of a large box. Although the second historical order includes the items C, after an intersection of each box and the to-be-separated item included in the to-be-processed order is extracted, the intersection includes no item C. Therefore, real loading rate of a box included in the second candidate separation configuration=(5×volume of an item A+10×volume of an item B)/volume of a large box. A reason of this is that the to-be-processed order includes no item C when the to-be-processed order is subsequently packed. Therefore, a volume of an item C does not need to be considered when the real loading rate of the box is calculated.

In the example shown in FIG. 4, the second candidate separation configuration includes two large boxes, a first large box is used to pack the items A, and a second large box is used to pack the items B. In this case, real loading rate of the first large box=(5×volume of an item A)/volume of the large box, and real loading rate of the second large box=(10×volume of an item B)/volume of the large box.

Each primary separation configuration may include one or more types of boxes, different types of boxes have different volumes, and different quantities of items packed in boxes of a same type may also lead to different real loading rates. Overall real loading rates of all boxes need to meet the preset condition in the candidate separation configuration.

Step S202: Determine a separation configuration of the to-be-processed order according to an optimization policy based on the at least one candidate separation configuration.

Optionally, the optimization policy may be that a quantity of used boxes is the smallest, a volume of a used box is the smallest, or separation costs are the lowest.

In this embodiment, the at least one level of matching is performed on the to-be-processed order and the historical order included in the separation database to obtain the candidate separation configuration, and the separation configuration of the to-be-processed order is determined according to the optimization policy based on the at least one candidate separation configuration. In this way, the separation configuration of the to-be-processed order is optimal, so that separation costs can be reduced.

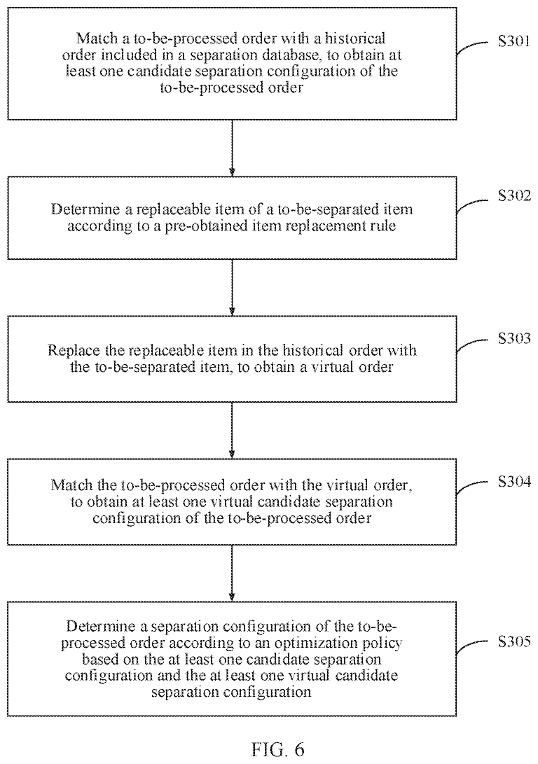

FIG. 6 is a flowchart of an item separation method according to Embodiment 3 of this application. Based on Embodiment 2, in this embodiment, a virtual order is generated according to an item replacement rule, to expand a matching range of a to-be-processed order, and a candidate separation configuration is further determined based on the virtual order. As shown in FIG. 6, the method in this embodiment includes the following steps.

Step S301: Match the to-be-processed order with a historical order included in a separation database, to obtain at least one candidate separation configuration of the to-be-processed order.

Each candidate separation configuration includes all or some separation configurations of at least one historical order, a combination of historical orders included in each candidate separation configuration covers at least a to-be-separated item included in the to-be-processed order, a real loading rate of a box included in each candidate separation configuration meets a preset condition, and the real loading rate is a real loading rate obtained when the box is used to pack the to-be-separated item. For a specific implementation of this step, refer to the related description of step S201 in Embodiment 2. Details are not described herein again.

Step S302: Determine a replaceable item of the to-be-separated item according to the pre-obtained item replacement rule.

The item replacement rule may be manually maintained, for example, a replaceable item is manually entered, or an item separation apparatus may determine the item replacement rule based on a type of an item, a quantity of items, and a type of a used box that are in the historical order. The item replacement rule includes at least one pair of replaceable items and a quantity of each type of replaceable items in each pair. Each pair of replaceable items usually include two types of items, the two types of items may be replaced with each other, and sums of three-dimensional sizes of the two types of items included in each pair of replaceable items are the same, or a difference between the sums of the three-dimensional sizes is less than a first threshold.

For example, the item replacement rule is that X items A may be replaced with Y items B, and both X and Y are greater than or equal to 1. In this case, a sum of three-dimensional sizes of the X items A is the same as a sum of three-dimensional sizes of the Y items B, or a difference between the sum of the three-dimensional sizes of the X items A and the sum of the three-dimensional sizes of the Y items B is less than the first threshold. The first threshold is greater than 0. Certainly, a smaller value of the first threshold is better, and a smaller value of the first threshold indicates a smaller difference between the sums of the three-dimensional sizes of the two types of items.

The item replacement rule may be continuously updated. When a new historical order is generated or a new item is added, the item separation apparatus may determine whether a new replaceable item needs to be added, or receive a replaceable item entered by a user.

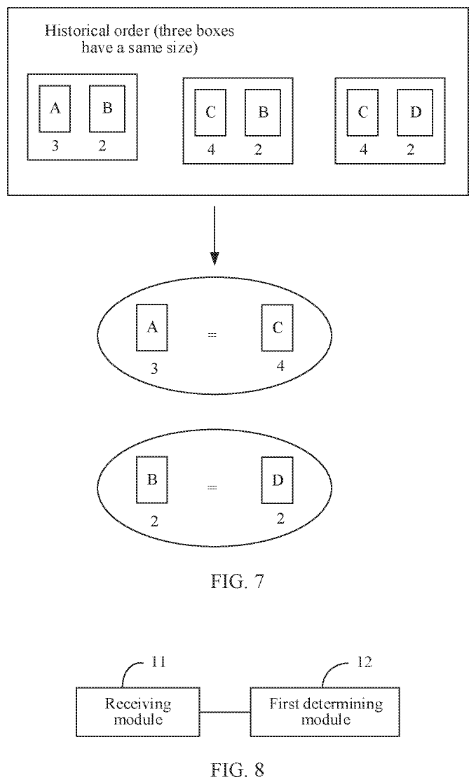

FIG. 7 is a schematic diagram of item replacement rule mining. As shown in FIG. 7, there are three boxes. A first box is loaded with three items A and two items B, a second box is loaded with four items C and two items B, and a third box is loaded with four items C and two items D. The three boxes have a same size. In this case, it can be learned from the first box and the second box that a three-dimensional size of the three items A is the same as or is approximately the same as a three-dimensional size of the four items C. Therefore, an item replacement rule that three items A and four items C may be replaced with each other can be obtained. It can be learned from the second box and the third box that a three-dimensional size of the two items B is the same as or is approximately the same as a three-dimensional size of the two items D. Therefore, it can be learned that two items B and two items D may be replaced with each other.

Step S303: Replace the replaceable item in the historical order with the to-be-separated item, to obtain the virtual order.

For example, if the to-be-separated item is A, and one item A may be replaced with one item D in the item replacement rule, all historical orders including items D are found from the separation database, and the items D in the historical orders including the items D are replaced with items A, to obtain virtual orders. There may be one or more virtual orders.

Step S304: Match the to-be-processed order with the virtual order, to obtain at least one virtual candidate separation configuration of the to-be-processed order.

Optionally, at least one level of matching is performed on the to-be-processed order and the virtual order, to obtain the at least one virtual candidate separation configuration of the to-be-processed order, and matching granularities are in descending order from first-level matching to last-level matching.

When the at least one level of matching is performed on the to-be-processed order and the virtual order, and no virtual candidate separation configuration is obtained in current-level matching, next-level matching is performed on the to-be-processed order and the virtual order. Alternatively, regardless of whether a virtual candidate separation configuration is obtained in current-level matching, next-level matching is performed on the to-be-processed order and the virtual order.

In this embodiment, a process of each level of matching includes the following steps: matching the to-be-processed order with the virtual order, to obtain at least one primary virtual separation configuration, where each primary virtual separation configuration includes all or some separation configurations of at least one virtual order, and a combination of virtual orders included in each primary virtual separation configuration covers at least the to-be-separated item included in the to-be-processed order; for each primary virtual separation configuration, calculating, based on a volume and/or a weight of the to-be-separated item, a real loading rate of each box included in the primary virtual separation configuration; and determining a virtual candidate separation configuration in the at least one primary virtual separation configuration, where the virtual candidate separation configuration is a primary virtual separation configuration in which a real loading rate of a box meets the preset condition.

A manner of calculating the real loading rate of each box included in the primary virtual separation configuration is the same as the manner of calculating the real loading rate of each box included in the primary separation configuration. For details, refer to the description in Embodiment 2. Details are not described herein again.

Step S305: Determine a separation configuration of the to-be-processed order according to an optimization policy based on the at least one candidate separation configuration and the at least one virtual candidate separation configuration.

It should be noted that, in this embodiment, when the to-be-processed order is matched with the historical order included in the separation database, it is possible that no candidate separation configuration is obtained through matching. In one manner, matching is performed based on the virtual order only when no candidate separation configuration is obtained through matching based on the historical order. In another manner, matching is performed based on the virtual order regardless of whether a candidate separation configuration is obtained through matching based on the historical order.

In this embodiment, the at least one level of matching is performed on the to-be-processed order and the historical order included in the separation database to obtain the at least one candidate separation configuration of the to-be-processed order, the replaceable item of the to-be-separated item is determined according to the pre-obtained item replacement rule, the replaceable item in the historical order is replaced with the to-be-separated item to obtain the virtual order, the to-be-processed order is matched with the virtual order to obtain the at least one virtual candidate separation configuration, and the separation configuration of the to-be-processed order is determined according to the optimization policy based on the at least one candidate separation configuration and the at least one virtual candidate separation configuration. In the method, the virtual order is generated according to the item replacement rule, so that the matching range of the to-be-processed order is expanded. Therefore, more candidate separation configurations can be obtained, and a most appropriate separation configuration is further determined for the to-be-processed order.

In Embodiment 2 and Embodiment 3, a heuristic algorithm may be used in all levels of matching, to determine a final separation configuration in a plurality of candidate separation configurations. However, the heuristic algorithm cannot ensure that an obtained solution is an optimal separation configuration of a to-be-processed order. Therefore, Embodiment 4 of this application provides an algorithm in which a separation configuration with lowest costs for a specific optimization target (for example, a quantity of used boxes is the smallest, a volume of a used box is the smallest, or separation costs are the lowest) is obtained based on a separation configuration of a historical order by using a dynamic programming algorithm. The dynamic programming algorithm includes the following steps.

Step 1: Establish and Initialize State Space Based on a to-be-Separated Order.

It is assumed that the to-be-separated order is {(item₁,itemQty₁), (item₂,itemQty₂), . . . , (itemₖ,itemQtyₖ)} itemᵢ indicates a type of an i^{th} type of item, and itemQtyᵢ, indicates a quantity of the i^{th} type of items. In this case, the state space is a set {S=[q₁, q₂ . . . , qₖ]|0≤qᵢ≤itemQtyᵢ, =1 . . . k} of k-dimensional vectors. It is assumed that a state at an initial moment is [0, 0, . . . , 0]. Because no box is allocated at this moment, costs (for example, a quantity of used boxes, a volume of a used box, or a price of a used box) in this state is 0. In this case, if initial costs in remaining states are infinite values, a value of k is 2, a value of itemQty₁ is 2, and a value of itemQty₂ is 3, the state at the initial moment is [0, 0], and the remaining states are [1, 0], [2, 0], [1, 1], [2, 1], [1, 2], [2, 2], [1, 3], and [2, 3], where [1, 0] indicates that a quantity of item₁ is 1, a quantity of item₂ is 0, and so on. Details are not listed herein one by one.

Step 2: Find, from the historical order, all SPUs including to-be-separated materials, to obtain a candidate SPU set, where each SPU also corresponds to a set of jump states.

A candidate SPU includes one or more types of to-be-separated materials. For example, if an SPU is loaded with {(item₁,n₁), (item₂,n₂), . . . , (itemₖ,nₖ)}, a set of jump states that corresponds to the SPU is {Sⱼᵤₘₚ=[q₁, q₂, . . . , qₖ]|0≤qᵢ≤nᵢ and real loading rate≥β, i=1 . . . k}. Each jump state herein indicates a subset of the SPU, and each subset needs to meet a real loading rate requirement.

Step 3: Traverse, in sequence from an initial k-dimensional state [0, 0, . . . , 0], all states in the state space. For each state, all the candidate SPUs in the candidate SPU set are traversed. If previous state cost value+jump state cost value<current state cost value, the current state cost value is updated to previous state cost value+jump state cost value, and a candidate SPU corresponding to the jump state cost value and a jump state of the candidate SPU are recorded.

For example, if a current state is [3, 0, . . . , 0], and has three previous states: [2, 0 . . . . , 0], [1, 0 . . . , 0], and [0, 0 . . . . , 0], in this case, the candidate SPUs are traversed to check a jump state of each candidate SPU and determine a specific previous state that is in the three previous states and that can jump to the current state [3, 0, . . . , 0] by adding a jump state (for example, if a candidate SPU can be loaded with three item₂, the previous state [0, 0, . . . , 0] can jump to the current state [3, 0, . . . , 0] by adding the candidate SPU). If a previous state can jump to the current state by adding a jump state, whether a current state cost value needs to be updated is further determined.

Step 4: Obtain a candidate SPU and a jump state on a path from the state [{itemQty₁, itemQty₂, . . . , itemQtyₖ} ] of the to-be-separated order to the initial state [0, 0, . . . , 0] based on an optimal jump relationship in step 3. These candidate SPUs are an optimal separation configuration of the to-be-separated order. The jump state corresponding to the candidate SPU is a material and a quantity of materials packed in each candidate SPU.

In another case, if there are a very large quantity (for example, tens of thousands) of boxes in a candidate separation configuration, and an optimal separation configuration is determined by using a heuristic algorithm, a processing speed is relatively low. Embodiment 5 of this application provides a machine learning algorithm. Some boxes having relatively low correlations may be selectively deleted to reduce a box set size without affecting a matching rate and matching quality, and even improve the two indicators (because only boxes having relatively high correlations are combined in this embodiment). In the machine learning algorithm, correlation sorting needs to be performed on a box set in a candidate separation configuration, and correlation sorting model training may include the following steps.

Step 1: Extract training data from a historical order, and for each type of SPU, defining a feature of the SPU as:

[itemQty₁, itemQty₂, . . . , itemQtyₙ] where n is a quantity of types of all items that can be listed, the feature is a high-dimensional sparse vector, and a positive sample and a negative sample are defined for each type of SPU.

For the positive sample, itemQtyᵢ indicates a real material packing manner (for example, itemQty₂ is 10, itemQty₅ is 8, and the others are 0) that is historically used in an order in which the SPU is located, and each manner is one positive sample.

For the negative sample, itemQtyᵢ indicates a material packing manner that is not historically used in an order in which the SPU is located. Herein, the material packing manner that is not used may be a randomly selected historical packaging manner corresponding to another SPU.

A label uses 0/1, the positive sample is 1, and the negative sample is 0.

Step 2: For each type of SPU, train a correlation model by using the training data obtained in step 1.

Because a high-dimensional sparse feature is entered, a method such as logistic regression (LR), a support vector machine (SVM), or deep learning may be used to train the training data.

A correlation prediction and sorting procedure may include the following steps.

Step 1: Enter a to-be-processed order, and convert the to-be-processed order into an eigenvector [itemQty₁, itemQty₂, . . . , itemQtyₙ], where itemQtyᵢ indicates a quantity of each type of to-be-separated items (n is a quantity of types of all items that can be listed). For example, if a specific type of item does not exist in the to-be-processed order, an eigenvector of the item is 0.

It is assumed that the to-be-processed order includes three types of items: item A, item D, and item F, there are five items A, there are 10 items D, and there are 10 items F. If there are eight types of items: item A, item B, item C, item D, item E, item F, item G, and item H that can be listed in total, the eigenvector of the to-be-processed order is [5, 0, 0, 10, 0, 10, 0, 0]

Step 2: Screen, from an SPU correlation sorting model library based on a candidate SPU set, out a correlation sorting model corresponding to each candidate SPU.

Step 3: Compare the eigenvector that is of the to-be-processed order and that is obtained in step 1 with the correlation sorting model that corresponds to the candidate SPU and that is obtained in step 2, to obtain a correlation score of each candidate SPU.

Step 4: Select one or more candidate SPUs with a highest correlation based on the correlation score that is of each candidate SPU and that is obtained in step 3.

FIG. 8 is a schematic structural diagram of an item separation apparatus according to Embodiment 6 of this application. As shown in FIG. 8, the item separation apparatus provided in this embodiment includes:

a receiving module 11, configured to receive a to-be-processed order, where the to-be-processed order includes a type of a to-be-separated item and a quantity of to-be-separated items; and

a first determining module 12, configured to determine a separation configuration of the to-be-processed order based on the to-be-processed order and a separation configuration of a historical order included in a separation database, where the separation configuration of the to-be-processed order includes a type of a box for packing the to-be-separated item and a quantity of boxes, and the separation configuration of the historical order includes a type of an item, a quantity of items, a type of a box for packing the item and a quantity of boxes.

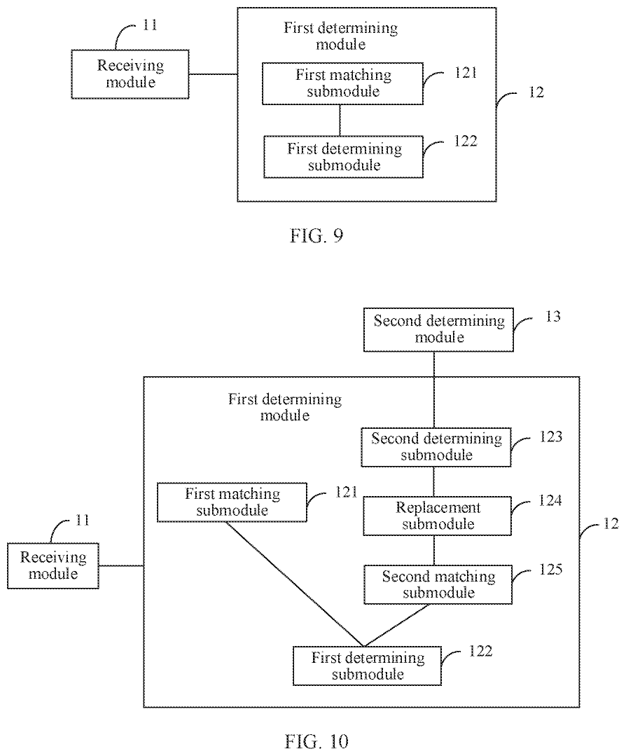

FIG. 9 is a schematic structural diagram of an item separation apparatus according to Embodiment 7 of this application. As shown in FIG. 9, based on the apparatus shown in FIG. 8, in the apparatus in this embodiment, the first determining module 12 includes a first matching submodule 121 and a first determining submodule 122.

The first matching submodule 121 is configured to match the to-be-processed order with the historical order included in the separation database, to obtain at least one candidate separation configuration of the to-be-processed order, where each candidate separation configuration includes all or some separation configurations of at least one historical order, a combination of historical orders included in each candidate separation configuration covers at least the to-be-separated item included in the to-be-processed order, a real loading rate of a box included in each candidate separation configuration meets a preset condition, and the real loading rate is a real loading rate obtained when the box is used to pack the to-be-separated item.

The first determining submodule 122 is configured to determine the separation configuration of the to-be-processed order according to an optimization policy based on the at least one candidate separation configuration.

Optionally, the first matching submodule 121 is specifically configured to perform at least one level of matching on the to-be-processed order and the historical order included in the separation database, to obtain the at least one candidate separation configuration of the to-be-processed order, where matching granularities are in descending order from first-level matching to last-level matching.

That the first matching submodule 121 performs at least one level of matching on the to-be-processed order and the historical order included in the separation database, to obtain the at least one candidate separation configuration of the to-be-processed order includes: when no candidate separation configuration is obtained in current-level matching, performing next-level matching on the to-be-processed order and the historical order included in the separation database.

Optionally, a process of each level of matching includes the following steps:

matching the to-be-processed order with the historical order based on a matching granularity of the current-level matching, to obtain at least one primary separation configuration, where each primary separation configuration includes all or some separation configurations of at least one historical order, and a combination of historical orders included in each primary separation configuration covers at least the to-be-separated item included in the to-be-processed order:

for each primary separation configuration, calculating, based on a volume and/or a weight of the to-be-separated item, a real loading rate of each box included in the primary separation configuration; and

determining a candidate separation configuration in the at least one primary separation configuration, where the candidate separation configuration is a primary separation configuration in which a real loading rate of a box meets the preset condition.

Correspondingly, the apparatus further includes a calculation module (not shown in the figure), configured to calculate, based on a type of an item and a quantity of items included in the separation database, a volume and a weight of each type of item included in the separation database.

Optionally, the calculation module is specifically configured to:

perform the following processing process for each item, where the processing process includes:

determining, in the historical order included in the separation database, a box set R loaded with the item;

establishing a model, where a type of an item included in each box in the box set R is C, a quantity of items included in each box in the box set R is Q, a vacancy rate tᵢ∈[0,1), a vacancy rate threshold β∈[0,1), a volume of the type of item is vᵢ, and ∃vᵢ∈V, where

the model meets:

restrictions: ∃rᵢ∈R and (1−tᵢ)×rᵢ≤Σⱼ₌₁^{C}vⱼ×qᵢ≤rᵢ; and

an optimization policy: minimizing t+t₂+ . . . +tₙ; and

calculating a volume vᵢ of each type of item and a vacancy rate tᵢ of each box, and if the vacancy rate tᵢ is greater than the vacancy rate threshold β, deleting the box whose vacancy rate tᵢ is greater than the vacancy rate threshold β from the box set R, and returning to perform the step of establishing a model, until vacancy rates tᵢ of all boxes in the box set R are less than the vacancy rate threshold β.

FIG. 10 is a schematic structural diagram of an item separation apparatus according to Embodiment 8 of this application. As shown in FIG. 10, based on the apparatus shown in FIG. 10, in the apparatus in this embodiment, the first determining module 12 further includes:

a second determining submodule 123, configured to determine a replaceable item of the to-be-separated item according to a pre-obtained item replacement rule, where the item replacement rule includes at least one pair of replaceable items and a quantity of each type of replaceable items in each pair, and sums of three-dimensional sizes of two types of items included in each pair of replaceable items are the same, or a difference between the sums of the three-dimensional sizes is less than a first threshold;

a replacement submodule 124, configured to replace the replaceable item in the historical order with the to-be-separated item, to obtain a virtual order; and

a second matching submodule 125, configured to match the to-be-processed order with the virtual order, to obtain at least one virtual candidate separation configuration of the to-be-processed order, where each virtual candidate separation configuration includes all or some separation configurations of at least one virtual order, a combination of virtual orders included in each virtual candidate separation configuration covers at least the to-be-separated item included in the to-be-processed order, and a real loading rate of a box included in each virtual candidate separation configuration meets the preset condition.

The first determining submodule 121 is specifically configured to determine the separation configuration of the to-be-processed order according to the optimization policy based on the at least one candidate separation configuration and the at least one virtual candidate separation configuration.

Correspondingly, the apparatus further includes a second determining module 13, configured to determine the item replacement rule based on the type of the item, the quantity of items, and the type of the used box that are in the historical order.

Optionally, the second matching submodule 125 is specifically configured to perform at least one level of matching on the to-be-processed order and the virtual order, to obtain the at least one virtual candidate separation configuration of the to-be-processed order, where matching granularities are in descending order from first-level matching to last-level matching.

That the second matching submodule 125 performs at least one level of matching on the to-be-processed order and the virtual order, to obtain the at least one virtual candidate separation configuration of the to-be-processed order includes: when no virtual candidate separation configuration is obtained in current-level matching, performing next-level matching on the to-be-processed order and the virtual order.

Optionally, a process of each level of matching includes the following steps:

matching the to-be-processed order with the virtual order, to obtain at least one primary virtual separation configuration, where each primary virtual separation configuration includes all or some separation configurations of at least one virtual order, and a combination of virtual orders included in each primary virtual separation configuration covers at least the to-be-separated item included in the to-be-processed order;

for each primary virtual separation configuration, calculating, based on a volume and/or a weight of the to-be-separated item, a real loading rate of each box included in the primary virtual separation configuration; and

determining a virtual candidate separation configuration in the at least one primary virtual separation configuration, where the virtual candidate separation configuration is a primary virtual separation configuration in which a real loading rate of a box meets the preset condition.

The item separation apparatuses provided in Embodiment 6 to Embodiment 8 may be configured to perform the methods provided in Embodiment 1 to Embodiment 5. Specific implementations and technical effects are similar, and details are not described herein again.

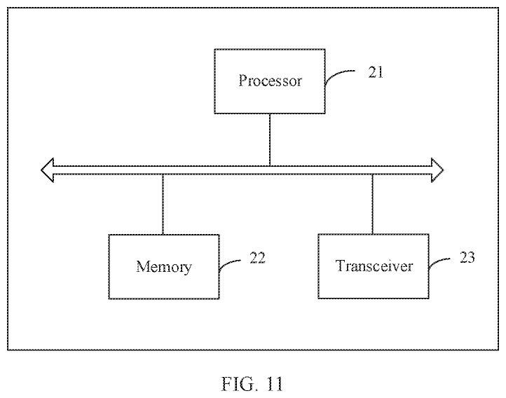

FIG. 11 is a schematic structural diagram of an item separation apparatus according to Embodiment 9 of this application. As shown in FIG. 11, the item separation apparatus provided in this embodiment includes a processor 21, a memory 22, and a transceiver 23. The memory 22 and the transceiver 23 are connected to and communicate with the processor 21 by using a bus, the memory 22 is configured to store an instruction, the transceiver 23 is configured to communicate with another device, and the processor 21 is configured to execute the instruction stored in the memory 22, so that the item separation apparatus performs the steps performed by the item separation apparatus in the foregoing method embodiments.

Embodiment 10 of this application further provides a computer-readable storage medium, applied to an item separation apparatus. The computer-readable storage medium stores an instruction. When the instruction is executed by a computing apparatus, the item separation apparatus is enabled to perform the methods provided in Embodiment 1 to Embodiment 5.

It may be understood that, a processor used in the item separation apparatus in this application may be a central processing unit (CPU), a general-purpose processor, a digital signal processor (DSP), an application-specific integrated circuit (ASIC), a field programmable gate array (FPGA) or another programmable logic device, a transistor logic device, a hardware component, or any combination thereof. The processor may implement or execute various example logical blocks, modules, and circuits described with reference to content disclosed in this application. Alternatively, the processor may be a combination of processors implementing a computing function, for example, a combination of one or more microprocessors, or a combination of a DSP and a microprocessor.

The bus in this application may be an industry standard architecture (ISA) bus, a peripheral component interconnect (PCI) bus, an extended industry standard architecture (EISA) bus, or the like. The bus may be classified into an address bus, a data bus, a control bus, and the like. For ease of representation, the bus in the accompanying drawings of this application is not limited to only one bus or only one type of bus.

In the several embodiments provided in this application, it should be understood that the disclosed apparatus and method may be implemented in another manner. For example, the described apparatus embodiment is merely an example. For example, the unit division is merely logical function division. There may be another division manner in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on an actual requirement to achieve an objective of a solution in the embodiments.

In addition, function units in the embodiments of this application may be integrated into one processing unit, or each of the units may exist alone physically, or two or more units may be integrated into one unit. The integrated unit may be implemented in a form of hardware, or may be implemented in a form of hardware and a software function unit.

What is claimed is:

1. An item separation method, comprising:
receiving, by at least one hardware processor, a to-be-processed order, wherein the to-be-processed order comprises a type of a to-be-separated item and a quantity of to-be-separated items; and
obtaining, by the at least one hardware processor, a separation configuration of the to-be-processed order based on the to-be-processed order and a separation configuration of a historical order comprised in a separation database, wherein the separation configuration of the to-be-processed order comprises a type of a box for packing the to-be-separated item and a first quantity of boxes, and wherein the separation configuration of the historical order comprises a type of an item, a quantity of items, a type of a box for packing the item, and a second quantity of boxes.

2. The method according to claim 1, wherein the obtaining a separation configuration of the to-be-processed order based on the to-be-processed order and a separation configuration of a historical order comprised in a separation database comprises:
matching the to-be-processed order with the historical order comprised in the separation database to obtain at least one candidate separation configuration of the to-be-processed order, wherein each candidate separation configuration comprises all or some separation configurations of at least one historical order, wherein a combination of historical orders comprised in each candidate separation configuration covers at least the to-be-separated item comprised in the to-be-processed order, wherein a real loading rate of a box comprised in each candidate separation configuration meets a preset condition, and wherein the real loading rate is a real loading rate obtained when the box is used to pack the to-be-separated item; and
obtaining the separation configuration of the to-be-processed order according to an optimization policy based on the at least one candidate separation configuration.

3. The method according to claim 2, wherein before the obtaining the separation configuration of the to-be-processed order according to an optimization policy based on the at least one candidate separation configuration, the method further comprises:
obtaining a replaceable item of the to-be-separated item according to a pre-obtained item replacement rule, wherein the item replacement rule comprises at least one pair of replaceable items and a quantity of each type of replaceable items in each pair, and wherein sums of three-dimensional sizes of two types of items comprised in each pair of replaceable items are the same, or a difference between the sums of the three-dimensional sizes is less than a first threshold;
replacing the replaceable item in the historical order with the to-be-separated item to obtain a virtual order; and
matching the to-be-processed order with the virtual order to obtain at least one virtual candidate separation configuration of the to-be-processed order, wherein each virtual candidate separation configuration comprises all or some separation configurations of at least one virtual order, wherein a combination of virtual orders comprised in each virtual candidate separation configuration covers at least the to-be-separated item comprised in the to-be-processed order, and wherein a real loading rate of a box comprised in each virtual candidate separation configuration meets the preset condition; and
wherein the obtaining the separation configuration of the to-be-processed order according to an optimization policy based on the at least one candidate separation configuration comprises:
obtaining the separation configuration of the to-be-processed order according to the optimization policy based on the at least one candidate separation configuration and the at least one virtual candidate separation configuration.

4. The method according to claim 3, wherein the matching the to-be-processed order with the virtual order to obtain at least one virtual candidate separation configuration of the to-be-processed order comprises:
performing at least one level of matching on the to-be-processed order and the virtual order to obtain the at least one virtual candidate separation configuration of the to-be-processed order, wherein matching granularities are in descending order from first-level matching to last-level matching.

5. The method according to claim 4, wherein a process of each level of matching comprises the following steps:
matching the to-be-processed order with the virtual order to obtain at least one primary virtual separation configuration, wherein each primary virtual separation configuration comprises all or some separation configurations of at least one virtual order, and wherein a combination of virtual orders comprised in each primary virtual separation configuration covers at least the to-be-separated item comprised in the to-be-processed order;
for each primary virtual separation configuration, calculating, based on at least one of a volume or a weight of the to-be-separated item, a real loading rate of each box comprised in the primary virtual separation configuration; and
obtaining a virtual candidate separation configuration in the at least one primary virtual separation configuration, wherein the virtual candidate separation configuration is a primary virtual separation configuration in which a real loading rate of a box meets the preset condition.

6. The method according to claim 3, wherein before the obtaining a replaceable item of the to-be-separated item according to a pre-obtained item replacement rule, the method further comprises:
obtaining the item replacement rule based on the type of the item, the quantity of items, and the type of the used box that are in the historical order.

7. The method according to claim 2, wherein the matching the to-be-processed order with the historical order comprised in the separation database to obtain at least one candidate separation configuration of the to-be-processed order comprises:
performing at least one level of matching on the to-be-processed order and the historical order comprised in the separation database to obtain the at least one candidate separation configuration of the to-be-processed order, wherein matching granularities are in descending order from first-level matching to last-level matching.

8. The method according to claim 7, wherein a process of each level of matching comprises the following steps:
matching the to-be-processed order with the historical order based on a matching granularity of the current-level matching to obtain at least one primary separation configuration, wherein each primary separation configuration comprises all or some separation configurations of at least one historical order, and wherein a combination of historical orders comprised in each primary separation configuration covers at least the to-be-separated item comprised in the to-be-processed order;
for each primary separation configuration, calculating, based on at least one of a volume or a weight of the to-be-separated item, a real loading rate of each box comprised in the primary separation configuration; and
obtaining a candidate separation configuration in the at least one primary separation configuration, wherein the candidate separation configuration is a primary separation configuration in which a real loading rate of a box meets the preset condition.

9. The method according to claim 8, further comprising:
calculating, based on a type of an item and a quantity of items comprised in the separation database, a volume and a weight of each type of item comprised in the separation database.

10. The method according to claim 9, wherein the calculating, based on a type of an item and a quantity of items comprised in the separation database, a volume of each type of item comprised in the separation database comprises:
performing the following processing process for each item, wherein the processing process comprises:
determining, in the historical order comprised in the separation database, a box set R loaded with the item;
establishing a model, wherein a type of an item comprised in each box in the box set R is C, a quantity of items comprised in each box in the box set R is Q, a vacancy rate tᵢ∈[0,1), a vacancy rate threshold β∈[0,1), a volume of the type of item is vᵢ, and ∃vᵢ∈V, wherein
the model meets:
restrictions ∃rᵢ∈R and (1−tᵢ)×rᵢ≤Σⱼ₌₁^{C}vⱼ×qᵢ≤rᵢ; and
an optimization policy: minimizing t₁+t₂+ . . . tₙ; and
calculating a volume vᵢ of each type of item and a vacancy rate tᵢ of each box, and if the vacancy rate tᵢ is greater than the vacancy rate threshold β, deleting the box whose vacancy rate tᵢ is greater than the vacancy rate threshold β from the box set R, and returning to perform the step of establishing a model, until vacancy rates tᵢ of all boxes in the box set R are less than the vacancy rate threshold β.

11. An item separation apparatus, comprising:
at least one processor; and
a non-transitory computer-readable storage medium coupled to the at least one processor and storing programming instructions for execution by the at least one processor, wherein the programming instructions instruct the at least one processor to perform operations comprising:
receiving a to-be-processed order, wherein the to-be-processed order comprises a type of a to-be-separated item and a quantity of to-be-separated items; and
obtaining a separation configuration of the to-be-processed order based on the to-be-processed order and a separation configuration of a historical order comprised in a separation database, wherein the separation configuration of the to-be-processed order comprises a type of a box for packing the to-be-separated item and a first quantity of boxes, and wherein the separation configuration of the historical order comprises a type of an item, a quantity of items, a type of a box for packing the item, and a second quantity of boxes.

12. The apparatus according to claim 11, wherein the operations further comprise:
matching the to-be-processed order with the historical order comprised in the separation database to obtain at least one candidate separation configuration of the to-be-processed order, wherein each candidate separation configuration comprises all or some separation configurations of at least one historical order, wherein a combination of historical orders comprised in each candidate separation configuration covers at least the to-be-separated item comprised in the to-be-processed order, wherein a real loading rate of a box comprised in each candidate separation configuration meets a preset condition, and wherein the real loading rate is a real loading rate obtained when the box is used to pack the to-be-separated item; and
obtaining the separation configuration of the to-be-processed order according to an optimization policy based on the at least one candidate separation configuration.

13. The apparatus according to claim 12, wherein the operations further comprise:
obtaining a replaceable item of the to-be-separated item according to a pre-obtained item replacement rule, wherein the item replacement rule comprises at least one pair of replaceable items and a quantity of each type of replaceable items in each pair, and wherein sums of three-dimensional sizes of two types of items comprised in each pair of replaceable items are the same, or a difference between the sums of the three-dimensional sizes is less than a first threshold;
replacing the replaceable item in the historical order with the to-be-separated item to obtain a virtual order; and
matching the to-be-processed order with the virtual order to obtain at least one virtual candidate separation configuration of the to-be-processed order, wherein each virtual candidate separation configuration comprises all or some separation configurations of at least one virtual order, wherein a combination of virtual orders comprised in each virtual candidate separation configuration covers at least the to-be-separated item comprised in the to-be-processed order, and wherein a real loading rate of a box comprised in each virtual candidate separation configuration meets the preset condition; and
wherein the obtaining the separation configuration of the to-be-processed order according to an optimization policy based on the at least one candidate separation configuration comprises:
obtaining the separation configuration of the to-be-processed order according to the optimization policy based on the at least one candidate separation configuration and the at least one virtual candidate separation configuration.

14. The apparatus according to claim 13, wherein the operations further comprise:
performing at least one level of matching on the to-be-processed order and the virtual order to obtain the at least one virtual candidate separation configuration of the to-be-processed order, wherein matching granularities are in descending order from first-level matching to last-level matching.

15. The apparatus according to claim 14, wherein the operations further comprise:
matching the to-be-processed order with the virtual order to obtain at least one primary virtual separation configuration, wherein each primary virtual separation configuration comprises all or some separation configurations of at least one virtual order, and wherein a combination of virtual orders comprised in each primary virtual separation configuration covers at least the to-be-separated item comprised in the to-be-processed order;
for each primary virtual separation configuration, calculating, based on at least one of a volume or a weight of the to-be-separated item, a real loading rate of each box comprised in the primary virtual separation configuration; and
obtaining a virtual candidate separation configuration in the at least one primary virtual separation configuration, wherein the virtual candidate separation configuration is a primary virtual separation configuration in which a real loading rate ofa box meets the preset condition.

16. The apparatus according to claim 13, wherein the operations further comprise:
obtaining the item replacement rule based on the type of the item, the quantity of items, and the type of the used box that are in the historical order.

17. The apparatus according to claim 12, wherein the operations further comprise:
performing at least one level of matching on the to-be-processed order and the historical order comprised in the separation database to obtain the at least one candidate separation configuration of the to-be-processed order, wherein matching granularities are in descending order from first-level matching to last-level matching.

18. The apparatus according to claim 17, wherein the operations further comprise:
matching the to-be-processed order with the historical order based on a matching granularity of the current-level matching to obtain at least one primary separation configuration, wherein each primary separation configuration comprises all or some separation configurations of at least one historical order, and wherein a combination of historical orders comprised in each primary separation configuration covers at least the to-be-separated item comprised in the to-be-processed order;
for each primary separation configuration, calculating, based on at least one of a volume or a weight of the to-be-separated item, a real loading rate of each box comprised in the primary separation configuration; and
obtaining a candidate separation configuration in the at least one primary separation configuration, wherein the candidate separation configuration is a primary separation configuration in which a real loading rate of a box meets the preset condition.

19. The apparatus according to claim 18, wherein the operations further comprise:
calculating, based on a type of an item and a quantity of items comprised in the separation database, a volume and a weight of each type of item comprised in the separation database.

20. The apparatus according to claim 19, wherein the operations further comprise:
performing the following processing process for each item, wherein the processing process comprises:
obtaining, in the historical order comprised in the separation database, a box set R loaded with the item;
establishing a model, wherein a type of an item comprised in each box in the box set R is C, a quantity of items comprised in each box in the box set R is Q, a vacancy rate tᵢ∈[0,1), a vacancy rate threshold β∈0,1), a volume of the type of item is vᵢ, and ∃vᵢ∈V wherein
the model meets:
restrictions: ∃rᵢ∈R and (1−tᵢ)×rᵢ≤Σⱼ₌₁^{C}vⱼ×qᵢ≤rᵢ; and
an optimization policy: minimizing t₁+t₂+ . . . +tₙ; and
calculating a volume vᵢ of each type of item and a vacancy rate tᵢ of each box, and if the vacancy rate tᵢ is greater than the vacancy rate threshold β, deleting the box whose vacancy rate tᵢ is greater than the vacancy rate threshold β from the box set R, and returning to perform the step of establishing a model, until vacancy rates tᵢ of all boxes in the box set R are less than the vacancy rate threshold β.
